(19) United States
(12) Patent Application Publication
(10) Pub. No.: US 2005/0186479 A1
(43) Pub. Date: Aug. 25, 2005

(54) Separator for electronic component and method for producing the same

(76) Inventors: Hiroki Totsuka, Shizuoka-shi (JP); Masahide Sugiyama, Shizuoka-shi (JP); Masanori Takahata, Shizuoka-shi (JP); Kazuhiko Fukaya, Shizuoka-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/064,379

(22) Filed: Feb. 23, 2005

(30) Foreign Application Priority Data
Feb. 24, 2004 (JP) 2004-048605
May 14, 2004 (JP) 2004-145430

(51) Int. Cl. H01M 2/16; B05D 3/00

(52) U.S. Cl. 429/251; 429/254; 427/373

(57) ABSTRACT

The present invention provides an electronic component separator that allows for easy thickness reduction and also has excellent mechanical strength, dimensional stability and heat resistance. This electronic component separator contains in a porous film made of a synthetic resin with a glass transition temperature of 180° C. or above, filler grains having a melting point of 180° C. or above or virtually no melting point, and the electronic component separator is produced by way of applying onto a base a coating material comprising (a) a synthetic resin with a glass transition temperature of 180° C. or above, (b) filler grains having a melting point of 180° C. or above or virtually no melting point, (c) at least one good solvent capable of dissolving the synthetic resin, and (d) at least one poor solvent incapable of dissolving the synthetic resin, and then drying the coated base to form a porous film.

### BACKGROUND OF THE INVENTION

1. Field of the Invention

This invention relates to an electronic component separator that can be used favorably in electronic components such as lithium ion batteries, polymer lithium batteries, aluminum electrolytic capacitors and electric double-layer capacitors, as well as a method for producing the same.

2. Description of the Background Art

In recent years, demands for such electronic components as lithium ion secondary batteries and polymer lithium secondary batteries are growing significantly in both industrial and commercial applications, partly due to the rising demands for electrical/electronic equipment, and partly due to the development of hybrid vehicles. Electrical/electronic equipment are rapidly advancing to offer larger capacities and higher functions, and accordingly the market is demanding lithium ion secondary batteries and polymer lithium secondary batteries also offering larger capacities and higher functions.

Lithium ion secondary batteries and polymer lithium secondary batteries have a common structure, which is described as follows: First, active material and lithium-containing oxide are mixed with a binder such as polyvinylidene fluoride in a 1-methyl-2-pyrrolidone, and then the mixture is formed into a sheet on an aluminum collector to obtain a positive electrode. Next, carbon material capable of occluding/releasing lithium ions is mixed with a binder such as polyvinylidene fluoride in a 1-methyl-2-pyrrolidone, and then the mixture is formed into a sheet on a copper collector to obtain a negative electrode. Then, a porous electrolyte film made of polyvinylidene fluoride, polyethylene, etc., is prepared, and the positive electrode, electrolyte film and negative electrode are rolled or laminated in this order to obtain an electrode body. This electrode body is impregnated with a driving electrolyte solution and then sealed in an aluminum case. The structure of an aluminum electrolytic capacitor is as follows: An etched positive electrode foil made of aluminum, on which a dielectric film is formed via chemical conversion, and an etched negative electrode foil made of aluminum, are rolled or laminated via a separator to obtain an electrode body. This electrode body is soaked in a driving electrolyte solution, sealed in an aluminum case and sealing material, and then the positive lead and negative lead are taken out through the sealing material in a manner preventing shorting. The structure of an electric double-layer capacitor is as follows: A mixture of active carbon, conductive agent and binder is pasted on both sides of positive and negative aluminum collector electrodes, and the electrodes are rolled or laminated via a separator to obtain an electrode body. This electrode body is impregnated with a driving electrolyte solution, packed in an aluminum case and sealing material, and then the positive lead and negative lead are taken out through the sealing material in a manner preventing shorting. Traditionally, separators used in the aforementioned lithium ion batteries and polymer lithium batteries are polyolefin porous films or non-woven fabrics as disclosed in Publication of Unexamined Patent Application No. 2003-317693. Separators used in aluminum electrolytic capacitors and electric double-layer capacitors are papers made of cellulose pulp or non-woven fabrics made of cellulose fibers, polyester fibers, acrylic fibers, etc.

In the meantime, experiments are carried out to advance the aforementioned electronic components to offer larger capacities and higher functions. To increase the capacity of electronic components, separators are needed that offer sufficient heat resistance, mechanical strength and dimensional stability to withstand the heat generated by a large-capacity electronic component through charge/discharge or the heat generated erratically by the component as a result of abnormal charge, etc. On the other hand, improvement of quick charge/discharge characteristics and high output characteristics is being attempted, among others, as a means for enhancing the function of electronic components, and there is a strong demand for thinner, more uniform separators that can be used in such improved components. However, the conventional separators mentioned above not only offer insufficient heat resistance, but they are also prone to through pores or lower mechanical strength if the thickness is reduced. As a result, chances will increase of internal shorting between the electrodes or of ion or electron migration concentrating in certain areas due to insufficient uniformity, eventually leading to lower reliability. One way to ensure mechanical strength of a thinner separator is to reduce its porosity. If porosity is reduced, however, internal resistance will increase to levels at which the separator will no longer satisfy the high-function requirements.

Studies are carried out to examine porous films made of heat-resistant resins in efforts to provide separators meeting the aforementioned requirements. Normally, the phase transition (micro phase transition) method is used as a means for making a heat-resistant resin porous. Basically, the phase transition method is based on the phase separation phenomenon of a polymer solution. When a polymer solution undergoes temperature change due to heating or cooling, when its concentration changes as a result of solvent vaporization or when its solvent composition changes due to contact with a non-solvent, the polymer solution will gelatinize from a stable solution state or undergo a phase separation and solidify. In general, the phase transition method involving vaporization is called the dry method, while the one involving contact with a non-solvent is called the wet method. In many cases, this phase separation phenomenon progresses asymmetrically. In other words, the concentration change due to vaporization occurs gradually from the surface of the solution toward the inside, and the change in solution composition due to contact with a non-solvent also progresses toward the inside from the contact interface of the polymer solution phase and non-solvent. Since the progress of phase separation varies between the solution surface or contact interface and the inside of the solution, an asymmetrical porous structure will be formed. The porous film produced by the phase transition method has a hierarchical structure in which the pores become smaller toward the film surface layer or dense layers (skin layers) containing no pores are formed. This characteristic becomes more prominent in porous films produced by the wet method. This hierarchical structure is favorable in a separation membrane, such as a reverse osmosis membrane, which offers a selective separation function. However, separators for electronic components will become vulnerable to performance drop if they have this structure, because in such separators ions or electrons move in both directions through repeated charging and discharging.

### SUMMARY OF THE INVENTION

In view of the above, a purpose of the present invention is to solve the aforementioned problems in electronic component separators by providing an electronic component separator that allows for easy thickness reduction and also has excellent mechanical strength, dimensional stability and heat resistance. Another purpose of the present invention is to provide a method for producing the electronic component separator that is capable of forming a uniform porous structure and is also productive.

To achieve the above purposes, the electronic component separator proposed by the present invention comprises a porous film made of a synthetic resin with a glass transition temperature of 180° C. or above, filler grains having a melting point of 180° C. or above or virtually no melting point contained in the porous film.

In addition, the electrode-integrated electronic component separator proposed by the present invention has on the active layer of electrodes each made of a laminated collector and active layer, a porous film made of a synthetic resin with a glass transition temperature of 180° C. or above and that contains filler grains having a melting point of 180° C. or virtually no melting point.

The first form of the method for producing the electronic component separator proposed by the present invention is to form a porous film by applying on a base a coating material containing (a) through (d) below and then drying the coated base:
(a) Synthetic resin with a glass transition temperature of 180° C. or above
(b) Filler grains having a melting point of 180° C. or above or virtually no melting point
(c) At least one good solvent capable of dissolving the aforementioned synthetic resin
(d) At least one poor solvent incapable of dissolving the aforementioned synthetic resin.

The second form of the method for producing the electronic component separator proposed by the present invention is to form a porous film by applying on a base a coating material containing (a) through (c) below, soaking the coated base in a poor solvent incapable of dissolving the applicable synthetic resin but which can be mixed with the following good solvent capable of dissolving the synthetic resin, and then drying the soaked base:
(a) Synthetic resin with a glass transition temperature of 180° C. or above
(b) Filler grains having a melting point of 180° C. or above or virtually no melting point
(c) At least one good solvent capable of dissolving the aforementioned synthetic resin.

### EFFECT OF THE INVENTION

The electronic component separator proposed by the present invention allows for easy thickness reduction and also has excellent mechanical strength, dimensional stability and heat resistance. This separator maintains various useful characteristics in a good condition, exhibits minimal shrinkage when heated, ensures high reliability, and provides excellent workability and productivity. Additionally, the method for producing the electronic component separator proposed by the present invention is capable of forming a uniform porous structure and is also productive. Therefore, the electronic component separator proposed by the present invention can be favorably used in electronic components such as lithium ion batteries, polymer lithium batteries, aluminum electrolytic capacitors and electric double-layer capacitors. In particular, it can be favorably used in large electronic components requiring higher heat resistance.

The electrode-integrated electronic component separator proposed by the present invention has the aforementioned porous film formed in contact and integrally with electrodes in a manner making it difficult for the electrodes and porous film to separate. Consequently, detachment of active material from the electrodes can be prevented in the battery production process, etc.

### DETAILED DESCRIPTION OF THE INVENTION

The synthetic resin composing the electronic component separator proposed by the present invention provides heat resistance represented by a glass transition temperature of 180° C. or above, as well as electrical insulation property. Specifically, such synthetic resin may comprise one or more of polyamide, polyamide imide, polyimide, polysulfone, polyether sulfone, polyphenyl sulfone, polyacrylonitrile, polyether etherketone, polyphenylene sulfide and polytetrafluoroethylene. These resins can be produced using known technologies. Since the heat resistance, dimensional stability and mechanical strength of this electronic component separator depend on the synthetic resin forming the porous film, the physical properties of the synthetic resin, especially its glass transition temperature, are important. Therefore, the present invention requires that the glass transition temperature of the synthetic resin be 180° C. or above. If the glass transition temperature is below 180° C., dimensional change or deformation will occur when the electronic component is heated to high temperatures of 180° C. or above. This is not desirable because it can cause the performance of the electronic component to deteriorate. The synthetic resin is exposed to a high-temperature environment of 200° C. or above during the production of the electronic component or in other environments in which the electronic component is used. Therefore, it is desirable that the synthetic resin have a grass transition temperature of 200° C. or above. The methods to measure and analyze the aforementioned grass transition temperature shall conform to JIS K-7121.

In the production method proposed by the present invention, which will be explained later, the synthetic resin is dissolved or dispersed in a solvent. Therefore, a synthetic resin that dissolves in a solvent is preferred, because the resulting porous film will have better mechanical strength and uniformity. Specifically, the synthetic resin used in the proposed production method should desirably comprise one or more of polyamide, polyamide imide, polyimide, polysulfone, polyether sulfone, polyphenyl sulfone and polyacrylonitrile. In particular, polyamide imide and polyphenyl sulfone are preferred because of their excellent mechanical strength.

In the present invention, it is possible to add a synthetic resin with a glass transition temperature of below 180° C., provided that the resulting mechanical strength, dimensional stability and heat resistance would not be affected. Addition of such synthetic resin will improve the wettability of the electrolyte solution used in the electronic component, and also provide other advantages such as higher retention and flexibility. If a synthetic resin with a glass transition temperature of below 180° C. is to be added, the content of such resin must be kept to 20 percent by weight or less of the total resin content. If the content of the synthetic resin with a glass transition temperature of below 180° C. exceeds 20 percent by weight of the total resin content, heat resistance will drop and achieving the purpose of the present invention will become difficult.

In the present invention, the porous film must contain filler grains. In other words, the electronic component separator proposed by the present invention comprises a porous film having continuous through pores and virtually no shielding structure, and this porous film must contain filler grains to achieve the aforementioned property. Existence of filler grains has the effect of preventing dense layers (skin layers) without pores from being formed when the synthetic resin is converted to a porous structure. Although the reason is not clear, one plausible explanation for this is that the solvent distributes unevenly between the resin interface and the filler grains distributed uniformly in the synthetic resin solution, which promotes formation of pores predominantly around the filler grains during the dry or wet production method proposed by the present invention. Since the filler grains are distributed uniformly at the surface and on the inside of the applied coating material, phase separation can occur uniformly in the thickness direction of the coating material. By providing filler grains to prevent formation of dense layers, a porous structure having continuous pores linking one side of the porous film to the other can be produced. When such porous structure is used to produce an electronic component, ion conduction and electron conduction inside the component will not be prevented.

The filler grains that can be used in the present invention must have a melting point of 180° C. or above or virtually no melting point. If the melting point is below 180° C., the grains will melt under heat and may block the pores in the porous structure. A material that easily dissolves in an electrolyte solution or gelatinizes is also undesirable, because it can promote clogging of the porous structure and thereby reduce the performance of the electronic component. Since conductive materials cause internal shorting, filler grains must have electrical insulation property. The shape of filler grain is not limited, and the grain can be amorphous or have a shape of sheet, needle or sphere. However, spherical fillers are most suitable for achieving a uniform dispersion throughout the porous film. Specific examples of filler material include: natural silica, synthetic silica, alumina, titanium oxide, glass and other inorganic grains with electrical insulation property; and polytetrafluoroethylene, bridged acrylic resin, benzoguanamine resin, bridged polyurethane, bridged styrene resin, melamine resin and other organic grains. Among others, inorganic grains with electrical insulation property and polytetrafluoroethylene grains are suitable, because they offer excellent chemical resistance, heat resistance and dispersibility. The method to measure the melting point of filler grains shall conform to JIS K-7121.

One-means for evaluating the continuity of pores in the porous film is to measure the Gurley air resistance as defined in JIS P8117. The lower the air resistance, the better the air permeability becomes. Therefore, electronic component separators should desirably have low air resistance. In the present invention, the air resistance should be kept to 100 sec/100 ml or below by adjusting the size and content of filler grains. A porous film with an air resistance in this range provides an excellent electronic component separator, because internal resistance in the electronic component can be reduced. Furthermore, the air resistance can be easily reduced to 30 sec/100 ml or below by optimizing the size and content of filler grains, in which case the resulting separator will become more favorable.

The primary average grain size of the filler grains used in the present invention is no more than one-half the thickness of the finally obtained porous film. Desirably, the maximum grain size should not exceed the film thickness. If the grain size is too large, there will be more grains projecting above the porous film surface, which can make the film thickness uneven. The most preferable primary average grain size is in the range of one-hundredth to one-tenth the film thickness. As long as the grain size is less than one-tenth the film thickness, formation of dense layers can be sufficiently prevented and therefore grain sizes above this level are not necessarily required. If the grain size is too small, formation of dense layers cannot be prevented and the aforementioned air resistance will increase.

The content of filler grains should desirably be 25 to 85 percent by weight of the total solid content of the porous film. The larger the content of filler grains, the less prominent dense layer formation becomes. However, it also reduces the mechanical strength of the porous film, and therefore the content of filler grains should desirably be kept to 85 percent by weight or less. If the content of filler grains is less than 25 percent by weight, the effect of preventing dense layer formation will decrease and the aforementioned air resistance will not be achieved, which is undesirable. An optimal content at which both the required mechanical strength and air resistance can be satisfied is 40 to 70 percent by weight.

The electronic component separator proposed by the present invention should desirably have a film thickness of 1 to 50 μm. Since the electronic component separator proposed by the present invention has sufficient strength that poses virtually no practical problem at a film thickness of 50 μm or less, any larger film thickness is not required. If the film thickness is below 1 μm, mechanical strength will decrease and handling ease will also drop, which will in turn have negative effect on productivity. A more preferable film thickness for the separator proposed by the present invention is 3 to 30 μm, or most preferably 5 to 15 μm. By making a thin porous film with a film thickness of 15 μm or less, an excellent electronic component can be achieved that has low internal resistance and exhibits sufficient mechanical strength in practical applications.

The electronic component separator proposed by the present invention should desirably have a porosity of 30 to 90 percent. If the porosity is lower than the aforementioned range, a higher internal resistance will affect the performance of the electronic component. If the porosity is higher than the aforementioned range, mechanical strength will drop and achieving the purpose of the present invention will become difficult. A more preferable range is 50 to 80 percent. A separator whose porosity is inside this range is especially desirable, because it provides sufficient mechanical strength, ensures low internal resistance, and also exhibits excellent ion conductance and electron conductance.

The electronic component separator proposed by the present invention should desirably have an average pore diameter of 0.01 to 10 μm as measured by the bubble point method. If the pore diameter is smaller than the aforementioned range, a higher internal resistance will affect the performance of the electronic component. If the pore diameter is larger than the aforementioned range, internal shorting will occur more easily, which is not desirable.

The electronic component separator proposed by the present invention should desirably have an open area ratio of 30 to 90 percent at the surface. If the open area ratio is too low, a higher internal resistance will affect the performance of the electronic component. If the open area ratio is too high, mechanical strength may drop.

In the present invention, the aforementioned porous film containing filler grains can be formed on active electrodes each comprising a laminated collector and active layer, in order to produce an electrode-integrated electronic component separator.

The electrode-integrated electronic component separator proposed by the present invention has positive and negative electrodes, each comprising a laminated collector and active layer. The collector can be made of any material as long as it is electrochemically stable and conductive. Among others, aluminum is used favorably for the positive electrode, while copper is used favorably for the negative electrode. Generally, a complex oxide of lithium and cobalt is used as the active material composing the active layer in the positive electrode. In addition, a complex oxide of lithium and nickel, and another containing manganese or other transition metal, are also favorable. The active material composing the active layer in the negative electrode may be any material as long as it is electrochemically stable and conductive, such as carbon black, graphite or other substance capable of occluding and releasing lithium ions. Grains of a selected active material are mixed into a binder and laminated/affixed onto the collector to form an active layer. Examples of the aforementioned binder include polyvinylidene fluoride resin or its copolymer resin, and polyacrylonitrile resin. However, other materials can also be used as long as they are insoluble in an electrolyte solution and electrochemically stable.

If used in an electronic component, the aforementioned electronic component separator proposed by the present invention offering high heat resistance, excellent air resistance, high mechanical strength and ease of thickness reduction contributes to low internal resistance, high capacity, excellent high-temperature resistance, high reliability and long life, among others. Therefore, it can be favorably used in lithium ion batteries, polymer lithium batteries, aluminum electrolytic capacitors and electric double-layer capacitors.

The method for producing the separator proposed by the present invention has a unique feature in the formation of a porous structure and offers excellent productivity. As mentioned earlier, known porous-structure formation methods tend to produce a film with dense layers. Using the production method proposed by the present invention, a porous film can be obtained without allowing dense layers to form.

One method for producing the electronic component separator proposed by the present invention is the dry method. Under the dry method, a coating material, containing (a) a synthetic resin with a glass transition temperature of 180° C. or above, (b) filler grains having a melting point of 180° C. or above or virtually no melting point, (c) at least one good solvent capable of dissolving the aforementioned synthetic resin, and (d) at least one poor solvent incapable of dissolving the aforementioned synthetic resin, is applied on a base and then dried to form a porous film, after which the base is removed. Here, the good solvent used in the coating material is not limited, and any solvent that can dissolve the synthetic resin is appropriate. Principal examples include: 1-methyl-2-pyrrolidone, N,N-dimethyl acetamide, N,N-dimethyl formaldehyde and other amide solvents; and 2-butanone, cyclohexane and other ketone solvents. The aforementioned poor solvent incapable of dissolving the synthetic resin is not limited, and for selection it suffices to check the solubility of the resin. Since the type, properties, physical characteristics and content of the poor solvent have significant bearing on the pore diameter, porosity and other characteristics of the porous film, the poor solvent should desirably be selected by understanding the following limitations: First, the poor solvent tends to result in a higher porosity of the porous film if its boiling point is higher than the boiling point of the good solvent. Additionally, although the poor solvent tends to make the film more porous as its content increases, an excessive content will increase the viscosity of the coating material, which will in turn reduce the handling ease and consequently, productivity. Preferably the boiling point of the poor solvent should be 10 to 20° C. higher than the boiling point of the good solvent, while the content of the poor solvent should be 10 to 30 percent by weight of the total solvent. Examples of poor solvents that can be used with the good solvents listed above include, but not limited to: ethylene glycol, diethylene glycol, glycerin and other glycols; octanol, decanol and other alcohols; nonane, decane and other aliphatic hydrocarbons; and phthalic acid dibutyl and other esters. The method to add aforementioned constituents (a) through (d) to the coating material is not limited. As an example, the synthetic resin can be dissolved in the good solvent, after which the filler grains can be added and dispersed, and then mixed with the poor solvent, which provides an easy way to prepare the coating material. The obtained coating material can be applied on the base by way of casting, etc. The base can be made of any smooth material, such as: polyolefin film, polyester filmand other resin films; aluminum and other metal foils; and various glasses. These bases can be surface-treated by exfoliation, simple bonding, etc., and any specification can be selected as deemed appropriate according to the application method of the coating material. The cast film applied on the base should be dried at temperatures between room temperature and around 180° C. to vaporize the solvents and thereby form a porous film on the base. The drying process may be performed under reduced pressure or normal pressure, or by means of air-drying. Finally, the porous film is peeled from the base to obtain the electronic component separator proposed by the present invention.

The electrode-integrated electronic component separator proposed by the present invention can be produced by applying, by way of casting, etc., the aforementioned coating material on active electrodes each comprising a laminated collector and active layer, followed by drying, and vaporization of solvents.

Another method for producing the electronic component separator proposed by the present invention is the wet method. Under the wet method, a coating material, containing (a) a synthetic resin with a glass transition temperature of 180° C. or above, (b) filler grains having a melting point of 180° C. or above or virtually no melting point, and (c) at least one good solvent capable of dissolving the aforementioned synthetic resin, is applied on a base, and then the coated base is soaked in a poor solvent incapable of dissolving the synthetic resin but which can be mixed with the aforementioned good solvent, after which the base is dried to form a porous film on top and finally the base is removed. Here, the good solvent used in the coating material is not limited, and good solvents similar to those mentioned under the aforementioned dry method can be used. The poor solvent that can be mixed with any of these good solvents and does not dissolve the synthetic resin is not limited, either, and for selection it suffices to check the solubility of the synthetic resin and mixability with the good solvent used. Examples of poor solvents that can be used with the good solvents listed above include, but not limited to: ethylene glycol, diethylene glycol, glycerin and other glycols; methanol, ethanol and other alcohols; water; and a mixture thereof. The method to add aforementioned constituents (a) through (c) to the coating material is not limited. As an example, the synthetic resin can be dissolved in the good solvent, after which the filler grains can be added and dispersed, which provides an easy way to prepare the coating material. The obtained coating material can be applied on the base by way of casting, etc. The base can be made of any smooth material, such as: polyolefin film, polyester film and other resin films; aluminum and other metal foils; and various glasses. These bases can be surface-treated by exfoliation, simple bonding, etc., and any specification can be selected as deemed appropriate according to the application method of the coating material. Next, the cast film applied on the base is soaked in the poor solvent, in order to promote phase separation by way of contact between the heat-resistant polymer solution phase and the poor solvent, thereby forming a layer having a porous structure on top of the base. Thereafter, the base with a porous layer formed on top is removed from the poor solvent, and then dried at temperatures between room temperature and around 180° C. to vaporize the poor solvent. The drying process may be performed under reduced pressure or normal pressure, or by means of air-drying. Finally, the porous film is peeled from the base to obtain the electronic component separator proposed by the present invention.

The aforementioned dry method and wet method proposed by the present invention are simple, productive and affordable methods that can efficiently and cost-effectively produce electronic component separators having good characteristics.

### EXAMPLES

The present invention is explained by using examples.

### Example 1

Polyamide imide with a glass transition temperature of 300° C. was dissolved in a good solvent comprising N,N-dimethyl acetamide, and then a poor solvent comprising ethylene glycol and filler grains comprising polytetrafluoroethylene grains with a primary average grain size of 0.25 μm and melting point of 320° C. were added and mixed to obtain a coating material. The obtained coating material had a solid content of 30 percent by weight, and the content of filler grains was 30 percent by weight of the solid content. Next, the aforementioned coating material was applied on a resin film base comprising polyethylene phthalate by way of casting, and then dried at 80° C. in a blow dryer to completely vaporize the solvents. Thereafter, the resin film base was peeled to obtain an electronic component separator proposed by the present invention. The thickness of the obtained porous film was 25 μm.

### Example 2

A porous film was obtained in the same manner as in Example 1, except that the coating weight was adjusted to produce a porous film with a thickness of 15 μm.

### Example 3

A porous film was obtained in the same manner as in Example 1, except that the coating weight was adjusted to produce a porous film with a thickness of 6 μm.

### Example 4

An electronic component separator proposed by the present invention was obtained in the same manner as in Example 1, except that the solid content of the coating material was changed to 30 percent by weight and the content of polytetrafluoroethylene grains was changed to 50 percent by weight of the solid content. The thickness of the obtained porous film was 15 μm.

### Example 5

An electronic component separator proposed by the present invention was obtained in the same manner as in Example 1, except that the solid content of the coating material was changed to 40 percent by weight and the content of polytetrafluoroethylene grains was changed to 80 percent by weight of the solid content. The thickness of the obtained porous film was 15 μm.

### Example 6

An electronic component separator proposed by the present invention was obtained in the same manner as in Example 1, except that the filler grains were changed to polytetrafluoroethylene grains with a primary average grain size of 3 μm and melting point of 320° C. The thickness of the obtained porous film was 15 μm.

### Example 7

An electronic component separator proposed by the present invention was obtained in the same manner as in Example 1, except that the filler grains were changed to glass grains with a primary average grain size of 1 μm and having virtually no melting point. The thickness of the obtained porous film was 15 μm.

### Example 8

An electronic component separator proposed by the present invention was obtained in the same manner as in Example 1, except that polyphenyl sulfone with a glass transition temperature of 185° C. was used instead of polyamide imide. The thickness of the obtained porous film was 10 μm.

### Example 9

An electronic component separator proposed by the present invention was obtained in the same manner as in Example 1, except that polyphenyl sulfone with a glass transition temperature of 220° C. was used instead of polyamide imide. The thickness of the obtained porous film was 10 μm.

### Example 10

Polyamide imide with a glass transition temperature of 300° C. was dissolved in a good solvent comprising N,N-dimethyl acetamide, and then filler grains comprising polytetrafluoroethylene grains with a primary average grain size of 0.25 μm and melting point of 320° C. were added and mixed to obtain a coating material. The obtained coating material had a solid content of 20 percent by weight, and the content of filler grains was 50 percent by weight of the solid content. Next, the aforementioned coating material was applied on a resin film base comprising polyethylene phthalate by way of casting, and then the resin film base with a cast film formed on top was soaked in distilled water to fully diffuse the solvent. The base was then removed from the water, and dried at 50° C. in a blow dryer to completely vaporize the solvent. Thereafter, the resin film base was peeled to obtain an electronic component separator proposed by the present invention. The thickness of the obtained porous film was 25 μm.

### Comparative Example 1

A drawn polyethylene porous film, which is widely used in lithium ion secondary batteries at the present, was prepared as a separator. The film thickness of this polyethylene separator was 20 μm.

### Comparative Example 2

A paper separator made of cellulose pulp, which is widely used in electric double-layer capacitors at the present, was prepared as a comparative separator. The film thickness of this paper separator was 30 μm.

### Comparative Example 3

Polyamide imide with a glass transition temperature of 300° C. was dissolved in a good solvent comprising N,N-dimethyl acetamide, and then a poor solvent comprising ethylene glycol was added and mixed to obtain a coating material. The obtained coating material had a solid content of 10 percent by weight, and this coating material contained no filler grains. Next, the aforementioned coating material was applied on a resin film base comprising polyethylene phthalate by way of casting, and then dried at 80° C. in a blow dryer to completely vaporize the solvent to form a porous film. Thereafter, the resin film base was peeled to obtain a comparative separator. The thickness of the obtained porous film was 25 μm.

### Comparative Example 4

Polyamide imide with a glass transition temperature of 300° C. was dissolved in a good solvent comprising N,N-dimethyl acetamide to obtain a coating material. The obtained coating material had a solid content of 10 percent by weight, and this coating material contained no filler grains. Next, the aforementioned coating material was applied on a resin film base comprising polyethylene phthalate by way of casting, and then the resin film base with a cast film formed on top was soaked in distilled water to fully diffuse the solvent. The base was removed from the water, and dried at 50° C. in a blow dryer to completely vaporize the solvent to obtain a porous film. Thereafter, the resin film base was peeled to obtain a comparative separator. The thickness of the obtained porous film was 25 μm.

### Comparative Example 5

A comparative separator was obtained in the same manner as in Example 1, except that the filler grains were changed to polyethylene grains with a primary average grain size of 6 μm and melting point of 123° C. The thickness of the obtained porous film was 15 μm.

The separators obtained in Examples 1 through 10 and Comparative Examples 1 through 5 above were subjected to the evaluations explained below, in order to evaluate their characteristics as an electronic component separator. Table 1 summarizes the types and glass transition temperatures of synthetic resins used in the production of these porous films, types, primary average grain sizes, melting points and contents per total solid content of filler grains also used in their production, as well as film thicknesses and ratios of filler grain size to film thickness of respective porous films. In Table 1, PTFE stands for polytetrafluoroethylene.

<Air Resistance>

Table 2 shows the air resistances of separators obtained by Examples and Comparative Examples, as measured by Gurley Densometer B (manufactured by Yasuda Seiki) in conformance with JIS P-8117.

TABLE 1

| | Synthetic resin | | Filler grain | | | | | |
|---|---|---|---|---|---|---|---|---|
| | | Glass | | Primary | | | | Filler |
| | | transition | | average | Melting | Content | Film | grain |
| | | temperature | | grain size | point | (% by | thickness | size/film |
| | Type | (° C.) | Type | (μm) | (° C.) | weight) | (μm) | thickness |
| Example 1 | Polyamide | 300 | PTFE | 0.25 | 320 | 30 | 25 | 0.01 |
| | imide | | | | | | | |
| Example 2 | Polyamide | 300 | PTFE | 0.25 | 320 | 30 | 15 | 0.02 |
| | imide | | | | | | | |
| Example 3 | Polyamide | 300 | PTFE | 0.25 | 320 | 30 | 6 | 0.04 |
| | imide | | | | | | | |
| Example 4 | Polyamide | 300 | PTFE | 0.25 | 320 | 50 | 15 | 0.02 |
| | imide | | | | | | | |
| Example 5 | Polyamide | 300 | PTFE | 0.25 | 320 | 80 | 15 | 0.02 |
| | imide | | | | | | | |
| Example 6 | Polyamide | 300 | PTFE | 3 | 320 | 30 | 15 | 0.20 |
| | imide | | | | | | | |
| Example 7 | Polyamide | 300 | Glass | 1 | — | 30 | 15 | 0.07 |
| | imide | | | | | | | |
| Example 8 | Polyphenyl | 185 | PTFE | 0.25 | 320 | 30 | 10 | 0.03 |
| | sulfone | | | | | | | |
| Example 9 | Polyphenyl | 220 | PTFE | 0.25 | 320 | 30 | 10 | 0.03 |
| | sulfone | | | | | | | |
| Example 10 | Polyamide | 300 | PTFE | 0.25 | 320 | 50 | 25 | 0.01 |
| | imide | | | | | | | |
| Comparative | Polyethylene | — | None | — | — | — | 20 | — |
| Example 1 | | | | | | | | |
| Comparative | Cellulose | — | None | — | — | — | 30 | — |
| Example 2 | | | | | | | | |
| Comparative | Polyamide | 300 | None | — | — | — | 25 | — |
| Example 3 | imide | | | | | | | |
| Comparative | Polyamide | 300 | None | — | — | — | 25 | — |
| Example 4 | imide | | | | | | | |
| Comparative | Polyamide | 300 | Polyethylene | 6 | 123 | 30 | 15 | 0.40 |
| Example 5 | imide | | | | | | | |

TABLE 2

| | Air |
|---|---|
| | resistance |
| | (sec/100 ml) |
| Example 1 | 120 |
| Example 2 | 54 |
| Example 3 | 16 |
| Example 4 | 3 |
| Example 5 | <1 |
| Example 6 | 28 |
| Example 7 | 17 |
| Example 8 | 20 |
| Example 9 | 22 |
| Example 10 | 5 |
| Comparative | 270 |
| Example 1 | |
| Comparative | 6 |
| Example 2 | |
| Comparative | >10000 |
| Example 3 | |
| Comparative | >10000 |
| Example 4 | |
| Comparative | 610 |
| Example 5 | |

The above results show that all separators obtained by Examples per the present invention had low air resistance, as well as uniform, continuous pores in the thickness direction of the porous film. On the other hand, the separators obtained by Comparative Examples 3 through 5 had high air resistance and consequently had dense layers in the porous film.

<Area Change Ratio>

The separator obtained by each Example or Comparative Example was cut to a 5×5 cm square to obtain a test piece, and then the test piece was sandwiched between two glass plates, each with a size of 10×10 cm and thickness of 5 mm. Then, the test piece/glass was placed stationary in an aluminum vat in horizontal position, and left for 24 hours in an oven adjusted to 150 or 200° C. to examine the change in area due to heat. Area change was evaluated by the area change ratio (=Area after test/Area before test: 25 cm²)×100%, to obtain a guideline for dimensional stability under heat. The results are shown in Table 3.

Table 3

| | Area change ratio (%) | |
|---|---|---|
| | 150° C. | 200° C. |
| Example 1 | 100.0 | 97.7 |
| Example 2 | 100.0 | 97.5 |
| Example 3 | 100.0 | 97.8 |
| Example 4 | 100.0 | 98.2 |
| Example 5 | 100.0 | 99.4 |
| Example 6 | 100.0 | 97.5 |
| Example 7 | 100.0 | 97.5 |
| Example 8 | 100.0 | 95.8 |
| Example 9 | 100.0 | 96.5 |
| Example 10 | 100.0 | 98.2 |
| Comparative | 48.1 | 12.1 |
| Example 1 | | |
| Comparative | 95.4 | 88.7 |
| Example 2 | | |
| Comparative | 100.0 | 96.9 |
| Example 3 | | |
| Comparative | 100.0 | 97.0 |
| Example 4 | | |
| Comparative | 89.1 | 77.5 |
| Example 5 | | |

The above results show that all separators obtained by Examples per the present invention, in which a heat-resistant synthetic resin was used, had good dimensional stability under heat. On the other hand, the separators obtained by Comparative Examples 1, 2 and 5, in which a heat-resistant synthetic resin was not used, dissolved fully and lost their original shape at 200° C.

<Ion Conductance>

Ion conductance was measured as follows: First, ethylene carbonate and dimethyl carbonate were mixed together at a weight ratio of 1:1, and LiPF₆ was dissolved in the solvent mixture to 1 mol/l. Each of the separators obtained by Examples 1 through 10 and Comparative Examples 1 through 5 was soaked in the obtained electrolyte solution to achieve vacuum impregnation, and then the separator was removed from the solvent and the solvent deposited on the surface was carefully wiped off. Next, ion conductance was measured on the resulting electronic component separator impregnated with the electrolyte solution, using the alternating-current impedance method. The measurement was performed in an ambient temperature of 20° C. using stainless steel electrodes. The results are shown in Table 4.

TABLE 4

| | Ion |
|---|---|
| | conductance σ |
| | (S/cm) |
| | 20° C. |
| Example 1 | 5.10 × 10⁻⁴ |
| Example 2 | 5.56 × 10⁻⁴ |
| Example 3 | 6.28 × 10⁻⁴ |
| Example 4 | 7.00 × 10⁻⁴ |
| Example 5 | 9.10 × 10⁻⁴ |
| Example 6 | 7.10 × 10⁻⁴ |
| Example 7 | 6.10 × 10⁻⁴ |
| Example 8 | 6.10 × 10⁻⁴ |
| Example 9 | 7.10 × 10⁻⁴ |
| Example 10 | 8.10 × 10⁻⁴ |
| Comparative | 2.10 × 10⁻⁴ |
| Example 1 | |
| Comparative | 3.90 × 10⁻⁴ |
| Example 2 | |
| Comparative | 5.10 × 10⁻⁶ |
| Example 3 | |
| Comparative | 4.80 × 10⁻⁶ |
| Example 4 | |
| Comparative | 1.08 × 10⁻⁴ |
| Example 5 | |

The above results show that all separators obtained by Examples per the present invention had better ion conductance than the separators obtained by Comparative Examples. In particular, the separators obtained by Comparative Examples 3 and 4 had significantly lower ion conductance than other samples, which made them practically unusable as electronic component separators.

<Shorting Pressure>

Internal shorting property was evaluated as follows: First, the separator (5×5 cm) obtained by each Example or Comparative Example was sandwiched between two stainless steel sheets (3×3 cm), and with a potential difference of 80 V created between the stainless steel electrodes, a pressure was applied to the electrodes from the opposite directions to measure shorting pressure as a guideline for internal shorting performance. Based on the measured ion conductance levels presented above, the separators obtained by Comparative Examples 3 and 4 were deemed unsuitable as electronic component separators and therefore excluded from this test. The results are shown in Table 5.

TABLE 5

| | Shorting |
|---|---|
| | pressure |
| | (kg/cm²⁾ |
| Example 1 | 260 |
| Example 2 | 230 |
| Example 3 | 205 |
| Example 4 | 240 |
| Example 5 | 255 |
| Example 6 | 240 |
| Example 7 | 240 |
| Example 8 | 235 |
| Example 9 | 235 |
| Example 10 | 255 |
| Comparative | 180 |
| Example 1 | |
| Comparative | 155 |
| Example 2 | |
| Comparative | Not tested. |
| Example 3 | |
| Comparative | Not tested. |
| Example 4 | |
| Comparative | 195 |
| Example 5 | |

The above results show that the electronic component separators obtained per the present invention had excellent resistance against internal shorting, exhibiting greater electrical insulation property than conventional separators. This excellent electrical insulation property is likely the result of sufficient mechanical strength and uniform porous structure of the separator.

As evident from the four sets of evaluation results presented above, the electronic component separators obtained per the present invention had uniform continuous pores in the thickness direction of the porous film and satisfied all of the required heat resistance, ion conductance and resistance against internal shorting. In view of the above, these electronic component separator obtained per the present invention can fully answer the needs of large-capacity, high-function electronic components available of late. By contrast, the comparative separators fall short of satisfying these requirements.

### Example 11

One hundred weight parts of LiCoO₂, 10 weight parts of graphite and 7 weight parts of polyvinylidene fluoride resin were dispersed in N-methylpyrrolidone and crushed in a mortar to obtain a paste-like active material. The obtained paste was applied onto an aluminum foil using an applicator, and then dried for 45 minutes at 70° C. until the paste was half dry. Next, the half-dry active layer was pressed to 80 percent of its original thickness immediately after the application, and then further dried for 5 hours at 60° C. to obtain a positive electrode.

The same coating material used in Example 1 was applied onto the active layer of the obtained positive electrode, and then dried in the same manner to form a porous film on the positive electrode, thereby obtaining an electrode-integrated electronic component separator.

### Example 12

One hundred weight parts of graphite grains and 5 weight parts of polyvinylidene fluoride resin were mixed into a paste in the same manner as in Example 11, and the obtained paste was applied onto a copper foil. Next, it was dried and pressed and again dried in the same manner as in Example 11 to obtain a negative electrode.

The same coating material used in Example 1 was applied onto the active layer of the obtained negative electrode, and then dried in the same manner to form a porous film on the negative electrode, thereby obtaining an electrode-integrated electronic component separator.

Falling propensity of the active layer was examined in the following manner.

The electrode-integrated electronic component separators obtained in Examples 11 and 12 were laminated with their respective porous layers facing together, and the laminate was placed on a horizontal glass plate with the positive electrode facing down. Then, a stainless steel cylinder (bottom surface area: 5 cm²) weighing 300 g was placed on top of the laminate. At this time, the aluminum foil of the lower electrode was affixed to the glass plate using double-sided adhesive tape. Next, the upper electrode-integrated separator, which was not affixed to the glass plate, was slowly pulled in one direction in sliding motion, to check for damage of the porous layer and active layers of electrodes. As a result, the active layer did not fall along with the porous layer from either of the electrode-integrated electronic component separators in the laminate. Furthermore, the porous layer had no damage on either separator, and the integral structure of the separators remained unchanged.

1. A separator for an electronic component comprising: a porous film made of a synthetic resin with a glass transition temperature of 180° C. or above; and filler grains contained in the porous film, said filler grains having a melting point of 180° C. or above or virtually no melting point.

2. The separator according to claim 1, wherein the synthetic resin comprises at least one selected from the group consisting of polyamide, polyamide imide, polyimide, polysulfone, polyether sulfone, polyphenyl sulfone, and polyacrylonitrile.

3. The separator according to claim 1, which has an air resistance of 100 sec/100 ml or below.

4. The separator according to claim 1, wherein the filler grains have a primary average grain size of no more than one-half the thickness of the porous film.

5. The separator according to claim 1, wherein the filler grains are inorganic grains with electrical insulation property or polytetrafluoroethylene grains.

6. The separator according to claim 1, wherein the filler grains is contained in an amount of 25% to 85% by weight of the total solid content of the porous film.

7. The separator according to claim 1, which has a film thickness of 1 to 50 μm.

8. An electrode-integrated separator for an electronic component, which is formed on an active layer of electrodes each made of a laminated collector and active layer, and which comprises:
a porous film made of a synthetic resin with a glass transition temperature of 180° C. or above; and filler grains contained in the porous film, said filler granis having a melting point of 180° C. or above or virtually no melting point.

9. A method for producing a separator for an electronic component, comprising:
applying a coating material containing (a) through (d) below onto a base:
(a) synthetic resin with a glass transition temperature of 180° C. or above,
(b) filler grains having a melting point of 180° C. or above or virtually no melting point,
(c) at least one good solvent capable of dissolving the synthetic resin,
(d) at least one poor solvent incapable of dissolving the synthetic resin; and
drying the coating material, thereby forming a porous film.

10. A method for producing a separator for an electronic component, comprising:
applying a coating material containing (a) through (c) below onto a base:
(a) synthetic resin with a glass transition temperature of 180° C. or above,
(b) filler grains having a melting point of 180° C. or above or virtually no melting point,
(c) at least one good solvent capable of dissolving the synthetic resin;
soaking the coated base in a poor solvent which is incapable of dissolving the synthetic resin but which can be mixed with a good solvent capable of dissolving the synthetic resin; and
drying the base, thereby forming a porous film.
